(19) United States
(12) Patent Application Publication
(10) Pub. No.: US 2016/0281906 A1
(43) Pub. Date: Sep. 29, 2016

(54) DEVICE FOR TREATING AND/OR PROCESSING BULK MATERIAL

(71) Applicant: BÜHLER AG, Uzwil (CH)

(72) Inventors: Walter SIGNER, Bazenheid (CH); Patrick SCHINNERL, Arnegg (CH); Heribert WEBER, Arbon (CH)

(21) Appl. No.: 15/024,872

(22) PCT Filed: Sep. 25, 2014
(86) PCT No.: PCT/EP2014/070567

§ 371 Date: May 19, 2016

(30) Foreign Application Priority Data
Sep. 25, 2013 (EP) 13186038.9

(51) Int. Cl. F16M 7/00; F16M 5/00

(52) U.S. Cl. CPC F16M 7/00; F16M 5/00

(57) ABSTRACT

A stationary device, which is mounted on at least one hydraulic and/or pneumatic suspension element, for treating and/or processing bulk material in the bulk material processing industry. At least one suspension element is hydraulically and/or pneumatically regulated and/or controlled dependent on the position and/or speed and/or acceleration and/or weight, whereby at least one perpendicular positioning of the device can be adjusted.

The invention relates to a stationary device, mounted on at least one hydraulic and/or pneumatic suspension element, for treating and/or processing bulk material in the bulk material processing industry.

Within the meaning of the present invention, “bulk material” is understood to mean bulk material in the form of powder, granules and pellets, which is used in particular in the bulk material processing industry, i.e. in the processing of cereal, cereal milling products and cereal end products of the milling industry (in particular milling of common wheat, durum wheat, rye, maize and/or barley) or the specialty milling industry (in particular hulling and/or milling of soybean, buckwheat, barley, spelt, millet/sorghum, pseudocereals and/or pulses), the production of teed for livestock and domestic animals, fish and crustaceans, the processing of oilseeds, the processing of biomass and production of energy pellets, industrial malting and malt-handling installations; the processing of cocoa beans, nuts and coffee beans, the production of building materials, the production of fertilizers, in the pharmaceutical industry or in solid-state chemistry.

CH 664 705 A5 of the Applicant, Bühler A G, CH-9240 Uzwil, discloses for example a device which is used to cool freshly pelletized bulk material using the countercurrent principle. The bulk material is fed to the device in the direction of the tip of the permeable base and is then distributed evenly in all directions. The treatment gas flows in from the permeable base and is extracted again in the upper region of the device. The base is then moved by means of an oscillation generator arranged in the conical base in order to support the flow of the bulk material, and the bulk material then leaves the device through an annular discharge gap arranged at the lower periphery of the wall of the treatment chamber. The throughput of the balk material and therefore the residence time can be set by means of a vertically adjustable annular dosing slider, the position of which relative to the permeable base determines the gap dimension.

Such a device has drawbacks in many aspects. The gap dimension cannot be regulated precisely with a dosing slider, in particular in the case of large treatment chamber diameters, and so such devices are operated either with an open or a closed dosing slider in a discontinuous or batch operation. Furthermore, cleaning such a device involves a great deal of effort, since the discharge gap is difficult to access and therefore the device has to be cleaned from the inside. Furthermore, the conical base is configured as a lattice base. During the treatment, particles of bulk material can clog the openings in the conical base or the particles of bulk material can drop through the lattice base, this possibly resulting in insufficient treatment, if any, of the bulk material.

DE 2 226 973 and DE 26 42 501 disclose a device mounted on coil springs, wherein air springs are proposed as an alternative bearing element for the vibrating treatment chamber of this device for coating granules with pulverulent material.

CH 291 799 discloses the use of pneumatic actuators for setting a throttle member of a device for treating granular material.

It is therefore the object of the invention to specify a device of the type mentioned at the beginning, which avoids the disadvantages of the prior art and allows in particular continuous operation, is easy to clean and has an improved base which has in particular less of a tendency toward clogging of the openings.

The object is achieved according to the independent claims.

The at least one suspension element is hydraulically and/or pneumatically regulated and/or controlled in a position-dependent and/or speed-dependent and/or acceleration-dependent and/or weight-dependent manner, with the result that at least one vertical positioning of the device is settable.

The suspension element is attached directly or indirectly to a fixed mounting surface in order to mount the device in a stationary manner, i.e. in a fixed position. Here, the possibility arises of precise and very reliable position-dependent and/or speed-dependent and/or acceleration-dependent and/or weight-dependent control and/or regulation of the device, which, however, is realized by way of simple means. The use according to the invention of suspension elements simplifies the device compared with devices known from the prior art. Here, the number of movable parts is reduced, this in turn increasing the reliability of a device according to the invention. Furthermore, a reduction in components allows a “hygienic design” construction with fewer dead spaces, corners and angles and thus allows the cleaning possibilities of such a device to be improved, in particular with regard to use in the feed or foodstuffs industry. The treatment and/or processing of large quantities of bulk material and an increased throughput are thus also allowed. To this end, a throughout can be controlled and/or regulated better.

The device is preferably configured as part of a machine for treating and/or processing bulk material in the balk material processing industry, and allows relative positioning of one machine part with respect to at least one further machine component, said relative positioning being hydraulically and/or pneumatically regulated and/or controlled by the at least one suspension element.

In a further preferred embodiment, during operation, the device or parts of the latter are moved with a vibration which is generated hydraulically and/or pneumatically in particular by the at least one suspension element. As a result, not only can the suspension element serve as an oscillation generator, but the suspension element itself also prevents the transmission of oscillations and vibrations.

In a further preferred embodiment, the device, or optionally the machine, comprises means for sensing the position and/or speed and/or acceleration in particular of the suspension element and/or of the device.

In a further preferred embodiment of the invention, the position sensing means comprise a resilient element, in particular a spring, and a force transducer. The determination of position, speed and/or acceleration data, for example of a gap dimension, is a method-relevant variable which has to be determined with sufficient precision. In particular when for example suspension elements, preferably air spring elements, are used to vertically adjust a base of a machine, the weight of the bulk material present in a treatment chamber can be determined from the pressure prevailing in the suspension element and by determining the position of the base. In this case, the base or a movable end of the suspension element is preferably connected by means of resilient elements to force transducers which are in turn fastened to a nonmovable component of the machine or to the ground. Alternatively, the force transducers can be fastened to a movable component of the device and/or machine and be connected by means of resilient elements to a nonmovable component of the device and/or machine or to a nonmovable end of the suspension element. The resilient elements are preferably configured as linear springs. Depending on the extension of the spring, the force exerted by the spring increases constantly and can therefore be used to determine the position of the base. Such a spring/force transducer arrangement also works very reliably with a vibrating base, in particular when the spring is additionally guided. Such a spring/force transducer arrangement can furthermore also be used for speed and/or acceleration sensing.

In a further preferred embodiment, weight sensing takes place via the pressure prevailing in the at least one suspension element. An advantage of the use of suspension elements is that the latter can be used not only as regulating and/or control elements and additionally as oscillation generators but also as measuring sensors, as already explained above, in order to measure a force exerted on the pneumatic element via the pressure prevailing in the pneumatic element.

In a further preferred embodiment of the invention, the at least one suspension element is configured as an air spring element. Within the meaning of the present invention, an air spring element is understood as meaning in particular an element which is also referred to as a bellows, air spring bellows, air spring, spring body, air bellows, air sleeve, air suspension with axial bellows, bellows air suspension, air bellows suspension system, air suspension installation, air cushion, air suspension or bellows cylinder.

In a further preferred embodiment of the invention, the at least one suspension element is configured as a plurality of air spring elements arranged one on top of another.

In particular, in each case two air spring elements can be arranged one on top of the other. The lower air spring element is used for example to reach an operating height of the device, while the upper air spring element can be used for example to set a gap dimension of a discharge gap. For cleaning, the air spring elements are completely voided, such that the device takes up the lowest achievable position. Preferably, a locking mechanism is present between the two air spring elements, such that, when the operating height is reached, the lower air spring element can be relaxed without the device dropping down. The upper air spring element can then be used for example to set a discharge gap dimension.

In a further preferred embodiment of the invention, at least one air spring element serves as an oscillation generator. The air spring elements can move the base with a vibration by varying the air pressure in the air spring element, and so it is possible to dispense with the attachment of additional oscillation generators.

The device preferably forms a substantially conical base that is permeable to a treatment gas and has an upwardly directed tip, said base forming, together with at least one chamber wall, a treatment chamber of a machine for treating bulk material, wherein the machine has a feed opening arranged on a side opposite the base. By way of the at least one suspension element, it is possible to set the positioning of the base, and this can vary the dimension of an, in particular annular, discharge gap present between the chamber wall and the base.

The base of the device is thus configured in a vertically adjustable manner and allows the dimension of the discharge gap present between the chamber wall and the base to be varied infinitely. Thus, it is possible to set the gap dimension in an infinitely variable manner, thereby allowing continuous operation of the device according to the invention. Furthermore, a more compact overall height compared with devices according to the prior art is possible with the same throughput. It is also possible to lower the base completely for cleaning purposes, such that the device according to the invention can be cleaned easily from the outside.

In a preferred embodiment of the invention, the device comprises at least one oscillation generator. The oscillation generator can move the device, in particular the base, and have a positive effect on the flow behavior of the bulk material. The flow behavior is not only influenced by bulk-material-specific properties such as size distribution, temperature, surface properties etc. of the bulk material, but is also dependent substantially on the opening angle of the conical base.

In a further preferred embodiment of the invention, the base is provided with louver openings. Within the meaning of the present invention, louver openings are understood to be openings which are each covered at least partially by a shieldlike part. Such louver openings are formed in particular by sheet metal bulges of the base. The sheet metal bulges are arranged in an imbricated pattern such that the openings are not visible when viewed from the tip of the conical base in the direction of the discharge gap. Such a configuration according to the invention allows an optimal feed or extraction of treatment gas. Nevertheless, bulk material cannot pass into the openings, since the latter are protected by the sheet metal bulges in the flow direction of the bulk material. Thus, the base is not clogged or fallen through by small fragments of bulk material, as in devices according to the prior art, this negatively influencing the performance of such a known device. Furthermore, a configuration according to the invention of the base considerably simplifies cleaning.

The base preferably consists of an extensive base element substantially in the form of a conical surface, frustoconical surface, conical surface segment or frustoconical surface segment, having at least one louver opening.

Such base elements are used for the modular configuration of a conical base for a device according to the invention. At this point, it should be noted that, within the meaning of the present invention, the term “cone” is not necessarily limited to embodiments with a circular base. In particular, the base can be polygonal as an approximation of a circle. Accordingly, the surface of the cone can consist of planar surface sections. Depending on the desired dimension of the base, a plurality of elements can be assembled into a modular configuration of a base.

The base preferably consists of a set made up of a substantially conical tip element and a plurality of extensive base elements substantially in the form of a conical surface segment, in each case having at least one louver opening. Thus, it is in particular possible to retrofit existing installations with a conical base having louver openings.

Preferably, there are three or four air spring elements, which are arranged for example at equal spacings from one another and or in a manner offset through 90° around the circumference of the base. As a result, in addition to a vertical movement of the base, a tilting movement of the tip of the base is also possible. This is advantageous in particular because the feed opening has to be directed exactly towards the tip of the base in order that the device is not filled one-sidedly or unevenly and consequently in order that the residence time of the bulk material is the same everywhere. Such an adjustment of the orientation of the base can also take place during operation of the device according to the invention. Furthermore, it is possible for uneven distribution of the bulk material to load the air spring elements differently and to result in incorrect orientation of the base. The air pressure of individual air spring elements can be increased or lowered individually such that the tip of the base always has the optimal orientation. The air spring elements simultaneously act as damping members and prevent the addition, such air spring elements are already known from the automotive industry, are available cost effectively, are technically proven and can be operated, at low air pressures of up to 1 MPa, and can thus be attached to a conventional compressed air connection.

During operation of a device according to the invention, the treatment gas, generally air, is extracted from above and therefore a negative pressure arises in the treatment chamber. In order to compensate this negative pressure, air flows through the permeable base and the bulk material. However, this upwardly directed air flow causes a false reading of the determined weight. In order to take this into account, a corresponding variable (fan performance, air flow rate, negative pressure in the treatment chamber, etc.) is used to correct the determined weight or the bulk material.

The invention furthermore provides for the use of at least one air spring element both for the positionally fixed, weight-bearing mounting of a device for treating and/or processing bulk material in the bulk material processing industry and for the position-dependent and/or speed-dependent and/or acceleration-dependent and/or weight-dependent, pneumatic regulation and/or control of at least one vertical positioning of the device, wherein the at least one air spring element bears at least a part of the weight of the device and optionally additionally the weight of bulk material to be treated and/or processed that is located on the machine part.

With the use according to the invention, it is in particular possible to move machine parts precisely and reliably. Such a use is advantageous in particular when the machine part to be moved vibrates during operation. The pneumatic and/or hydraulic elements can furthermore likewise be used as oscillation generators. Vibrating machine parts or machine parts that are moved with a vibration are preferably likewise equipped, for position sensing, with an arrangement of a resilient element and a force transducer, as explained above. Furthermore, it is possible to determine the force exerted by the pneumatic and/or hydraulic elements from the pressure prevailing in the elements, optionally with a position of the machine part being used. The exerted force can be used for example for weight determination.

The invention is explained in more detail in the following text with reference to a preferred exemplary embodiment in conjunction with the drawings, in which:

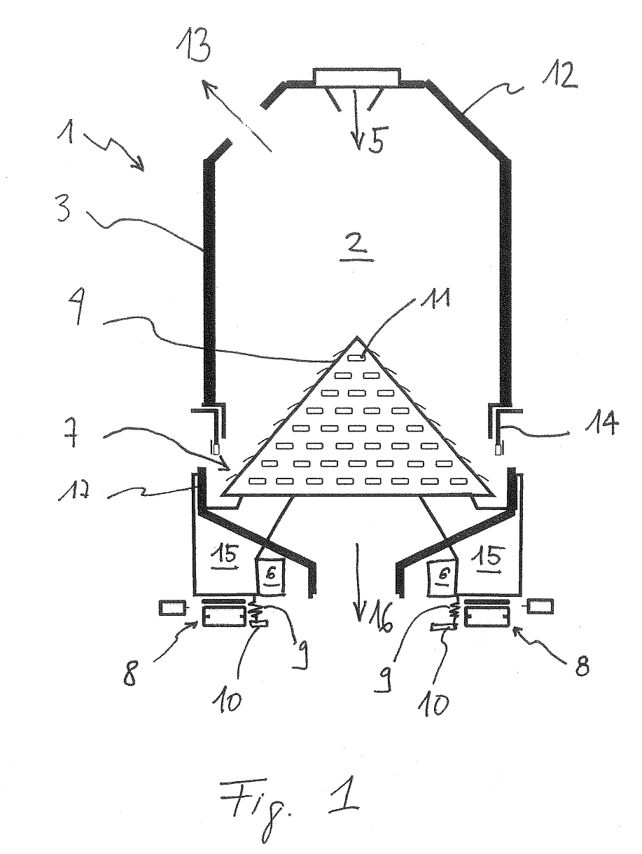

FIG. 1 shows a schematic sectional view through a preferred embodiment of a machine according to the invention with the base in a maintenance position;

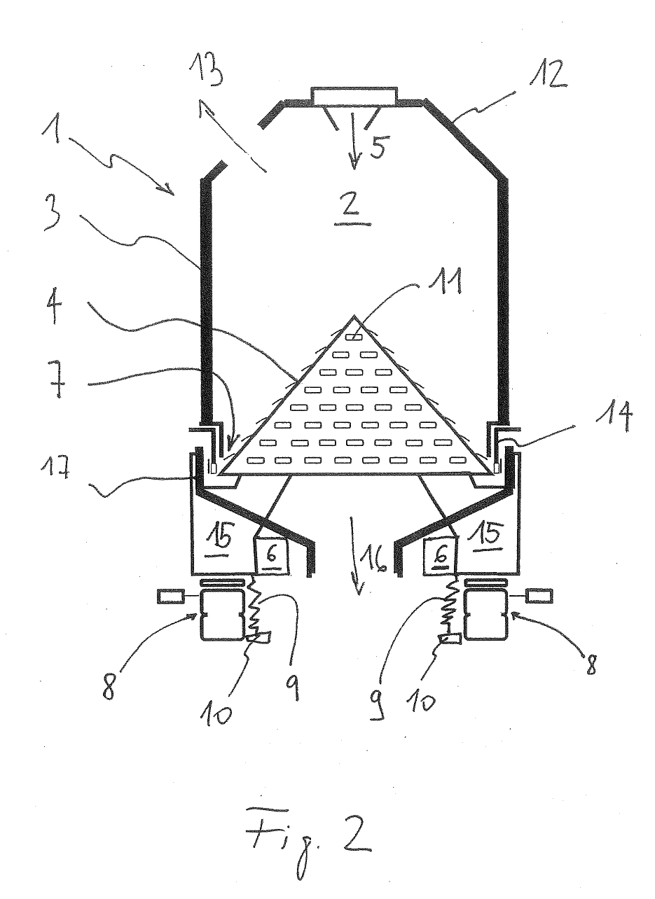

FIG. 2 shows a schematic sectional view of the machine in FIG. 1 with the base in an operating position and the discharge gap open;

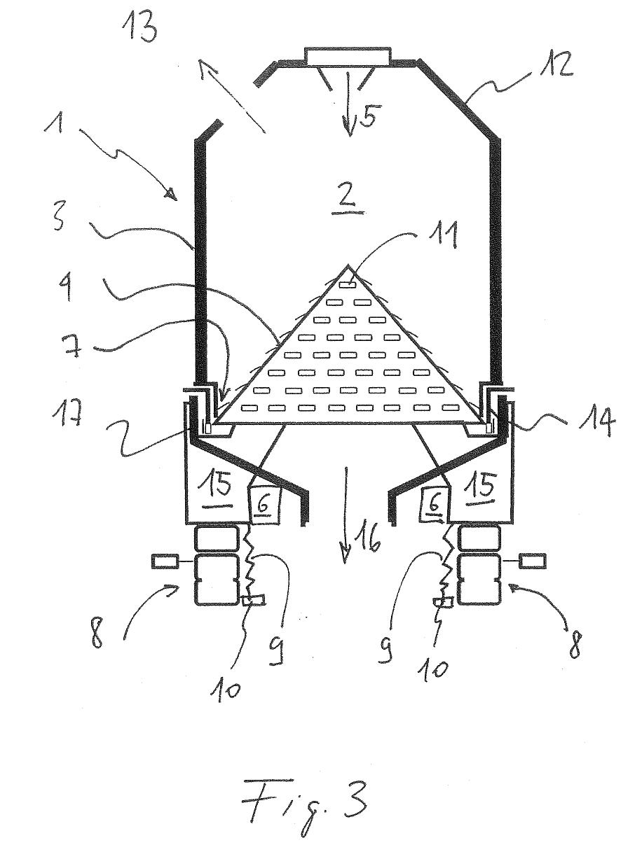

FIG. 3 shows a schematic sectional view of the machine in FIG. 1 with the base in an operating position and the discharge gap closed;

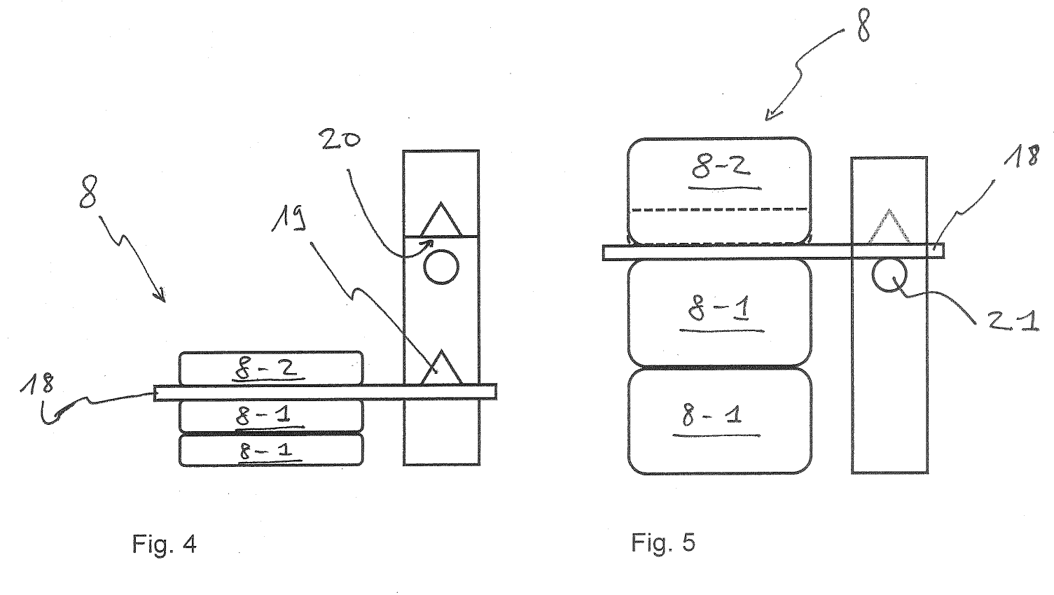

FIG. 4 shows a schematic view of the lifting mechanism of the machine according to the invention in a maintenance position;

FIG. 5 shows a schematic view of the lifting mechanism in FIG. 4 in an operating position;

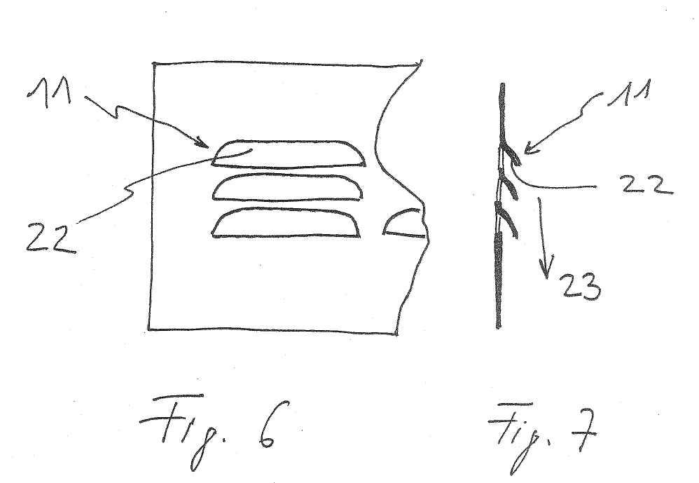

FIG. 6 shows a schematic plan view of the louver openings;

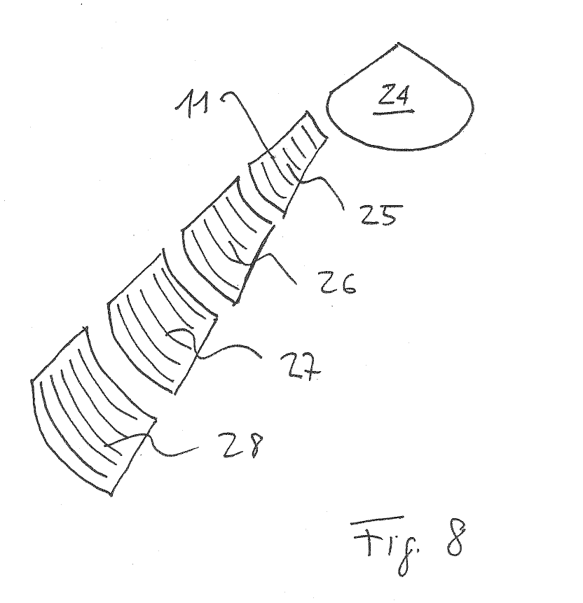

FIG. 7 shows a schematic sectional view of the louver openings in FIG. 6;

FIG. 8 shows a schematic perspective view of a set according to the invention.

FIGS. 1, 2 and 3 schematically illustrate a machine 1. The machine 1 comprises a treatment chamber 2 which is formed at the sides by a substantially cylindrical chamber wall 3, at the top by a cover 12 and at the bottom by a base 4. The base 4 has a conical shape with an upwardly directed tip. Arranged precisely above the tip of the base 4 is a feed opening (illustrated schematically by the arrow 5), which is provided with deflectors for deflecting the bulk material precisely onto the tip of the base 4. The base 4 has louver openings, of which only one is provided with the reference sign 11 for the sake of clarity, while the cover 12 furthermore has an extraction opening (illustrated schematically by way of the arrow 13) which allows extraction of air. Air can thus be drawn in through the openings 11 in the base 4 and flows through the bulk material present in the chamber.

The louver openings 11 are formed by sheet metal bulges and are arranged in an “imbricated pattern”, such that bulk material that drops down from the feed opening 5 cannot pass into the openings 10. The louver openings are visible separately in FIGS. 6 and 7.

The base 4 is located in its lowest position in the machine 1 illustrated in FIG. 1, such that the discharge gap illustrated schematically by way of the arrow 7 is open. In order to seal off the treatment chamber 2, an annular metal sheet 14 is arranged in the bottom region of the chamber wall 3, such that, with the discharge gap 7 closed, air can flow only through the louver openings 10 in the base 4. The base 4 is supported on four supporting elements 15, of which only two are visible in FIGS. 1 to 3 and to which a downwardly conical discharge base 17 that is provided with a central discharge opening 16 is also fastened.

The base 4 and the discharge base 17 are vertically adjustable via the supporting elements 15 by means of an air spring element arrangement 8. An air spring element arrangement 8 is schematically illustrated separately in FIGS. 4 and 5.

The base 4 is in the maintenance position in the machine 1 illustrated in FIG. 1, in which case the air spring elements 8-1 and 8-2 of the: air spring element arrangement 8 are not pressurized and the base 4 rests on stop elements (not illustrated) by way of the supporting elements 15 and the discharge base 17. In the maintenance position, the discharge gap 7 is readily accessible from the outside for cleaning or inspection.

The functioning of the air spring elements is more clearly apparent from FIGS. 4 and 5. The state illustrated in FIG. 3 corresponds to that in FIG. 1, while the state of the air spring elements that is shown in FIGS. 2 and 3 is more clearly apparent from FIG. 5.

An air spring element arrangement 8 consists of two air spring elements 8-1 and 8-2. The lower air spring element 8-1 is configured as what is referred to as a double bellows element. Arranged between the air spring element 8-1 and the air spring element 8-2 is a holding plate 18 having a centering element 19. In order to reach an operating position, only the air spring element 8-1 is pressurized, until the centering element 19 is accommodated in a correspondingly shaped centering opening 20. The holding plate 18 can subsequently be locked in the operating position by way of a pin 21, which is actuated manually, mechanically, hydraulically or pneumatically. The air spring element 8-1 can then be relaxed, since the locked holding plate 18 holds the base 4 in the operating position. Alternatively, the holding plate 18 can be placed on the pin 21 in a centering manner when the air spring element 8-1 is relaxed.

In order to set the desired discharge gap dimension, in each case only the air spring element 8-2 is pressurized. In this case, the broken line schematically shows the state of the air spring element 8-2 at the maximum discharge gap dimension, as illustrated in FIG. 2, while the solid line shows the state of the air spring element 8-2 with the discharge gap 7 closed, as illustrated in FIG. 3. By changing the pressure in the air spring element 8-2, the discharge gap dimension can thus be set infinitely.

Unbalance motors are fastened as oscillation generators 6 to each of the supporting elements 15. The number and/or arrangement of the oscillation generators 6 is dependent on the desired type of oscillation (horizontal, vertical, or a combination thereof). It should be noted here that when a plurality of oscillation generators 6 are used, in order to position the oscillation generators 6, further factors, for example the center of gravity of the moved component and generated force couples have to be taken into consideration.

One end of a linear spring 9 is fastened to in each case one supporting element 15, the other end of said spring 9 interacting with a force transducer 10 fastened to a support frame (not illustrated). The extension of the spring 9 and consequently the position of the base 4 can be determined from the force exerted by the spring 9 and determined by the force transducer 10. However, it is also conceivable for the force transducer 9 to be fastened to the holding plate 18.

The pressure in the air spring elements 8-2 is controlled by electropneumatic pressure regulators. The weight of the bulk material present in the treatment chamber 3 can be determined from the position of the base 4 and from the pressure prevailing in the air spring elements 8-2. By using further parameters, for example the density of the bulk material, the filling level of the treatment chamber and consequently the residence time of the bulk material can be set precisely. Filling level sensors, for example a rotor probe, can thus be dispensed with.

The louver openings 11 are more clearly visible in FIGS. 6 and 7. Said louver openings 11 are formed by sheet metal bulges 22 which each open up an opening and are arranged in a shieldlike manner over the opening. In this case, air can flow freely, while bulk material, which moves in the direction of the arrow 23, cannot pass into the openings.

FIG. 8 illustrates a schematic perspective view of a set according to the invention which is used as a base 4 for a machine illustrated in FIGS. 1 to 3. The set consists of a substantially conical tip element 24 and a plurality of extensive elements 25, 26, 27 and 28 that are substantially in the form of a conical surface segment, wherein in each case only one element 25, 26, 27 and 28 is shown in FIG. 8. In each case one element 25, 26, 27 and 26 forms an arc section of the conical base 4 with the same angle, but allows a different diameter of the base 4, depending on the arrangement. Depending on the desired cone dimension, the tip element 24 is combined with and supplemented by the other elements 25 to 28. The elements 25 to 28 each allow the flexible and modular configuration of the base 4. In the event of damage, it is possible to replace only one element.

1. A stationary device, mounted on at least one of an hydraulic and a pneumatic suspension element, for at least one of treating and processing bulk material in the bulk material processing industry,
wherein the at least one suspension element is at least one of regulated and controlled at least one of hydraulically and pneumatically in a manner selected from the group of position-dependent speed-dependent, acceleration-dependent and weight-dependent manner, with a result that at least one vertical positioning of the device is settable.

2. The device as claimed in claim 1, wherein the device is part of a machine for at least one of treating and processing bulk material in the bulk material processing industry, and relative positioning of one machine part with respect to at least one further machine component is at least one of regulated and controlled at least one of hydraulically and pneumatically by the at least one suspension element.

3. The device as claimed in claim 1, wherein, during operation, the device is moved with a vibration which is generated at least one of hydraulically and pneumatically.

4. The device as claimed in claim 1, wherein the device comprises means for sensing at least one of a position, speed and acceleration of at least one of the suspension element and of the device.

5. The device as claimed in claim 4, wherein the mea for sensing comprise a resilient element and a force transducer.

6. The device as claimed in claim 1, wherein weight sensing takes place via a pressure prevailing in the at least one suspension element.

7. The device as claimed in claim 1, wherein the at least one suspension element is configured as an air spring element.

8. The device as claimed in claim 7, wherein the at least one suspension element is configured as a plurality of air spring elements arranged one on top of another.

9. The device-with-at-least-one-suspension-element as claimed in claim 7, wherein at least one air spring element serves as an oscillation generator.

10. The device as claimed in claim 1, wherein the device forms a conical base that is permeable to a treatment gas and has an upwardly directed tip, said base forming, together with at least one chamber wall, a treatment chamber of a machine for treating bulk material, the machine has a feed opening arranged on a side opposite the base, and a dimension of a discharge gap present between the chamber wall and the base is variable by setting the positioning of the base by way of the at least one suspension element.

11. The device as claimed in claim 10, wherein the device comprises at least one oscillation generator.

12. The device as claimed in claim 10, wherein the base is provided with louver openings.

13. The device as claimed in claim 10, wherein the base consists of at least one extensive base element in the form of a conical surface, frustoconical surface, conical surface segment or frustoconical surface segment, having at least one louver opening.

14. The device as claimed in claim 10, wherein the base is formed by a set made up of a conical tip element and a plurality of extensive base elements in the form of a conical surface segment, in each case having at least one louver opening.

15. (canceled)
